(19) United States
(12) Patent Application Publication
(10) Pub. No.: US 2009/0089129 A1
(43) Pub. Date: Apr. 2, 2009

(54) Automated time budgeting

(76) Inventors: Mark Terrance Polson, Salt lake City, UT (US); Mac Gregory Newbold, Salt Lake City, UT (US)

Correspondence Address: Mark Terrance Polson, 1163 South 300 East, Salt Lake City, UT, 84111, US

(21) Appl. No.: 11/904,535

(22) Filed: Sep. 27, 2007

(51) Int. Cl. G06F 9/46

(52) U.S. Cl. 705/8

(57) ABSTRACT

Dynamic schedules are created by using a budgeting process for allocating time. Time available is first allocated to the system. Once time resources are allocated, fixed tasks are subtracted out of the time resources, leaving only flexible time which the user will use for all other tasks. Variable tasks may be added by entering due date, task description, task dependencies, and priority. An algorithm is used to maximize the user's schedule. The algorithm schedules rapidly, prevents late tasks, and readjusts to accommodate for unplanned events or new tasks.

### FIELD OF INVENTION

The present invention generally relates to a computer and Internet based system for automated time and project management using a budgeting method for allocating time.

### BACKGROUND OF THE INVENTION

Traditional time and project management systems work to fill time up by manually adding and readjusting all the added tasks. Several problems arise from this methodology: the user must manually calculate how to best use their time, which is a time consuming and error prone process. The user must continuously readjust their schedule due to new tasks being constantly added and increased multitasking in the work force. As more tasks are added the complexity of scheduling becomes exponentially difficult.

Project management in some cases works to ensure that tasks stay on schedule. However, the resources that should be constantly monitored are often neglected. The previous systems assume that everything will work out as planned, but more and more often this is not the case. The digital age has increased the speed at which tasks change, requiring multitasking and flexibility that wasn't previously needed.

Gantt charts and to-do lists historically have solved most time management processes, however the digital age has increased the amount of change and multitasking. Tasks can trickle down from management in a matter of minutes with email and other forms of digital communication. More and more the modern day digital worker must shuffle tasks constantly to meet deadlines, and handle the dynamic nature of workflow.

The Gantt chart approach is difficult as more and more tasks become very small in time. Traditionally there were many tasks that spanned a long period of time, several months to several years. However today more and more tasks can be completed very rapidly due mainly to new software and computing power. Instead of having only a few projects, today many workers are inundated with hundreds of tasks per year, from more sources than in the past. The worker must continuously determine which of many tasks should be worked on today. Often, interruptions occur or new tasks are added. In the workflow process, tasks often get bottlenecked by other workers. The modern day worker needs to be able to calculate which is the next best action, now more than ever. What is needed is an integrated time and project management system that will dynamically update and accommodate flexibility.

The integration of traditional time management and project management leaves the modern worker overwhelmed to know which tasks should be done right now. A better system for allocating time resources is in high demand.

### SUMMARY OF THE INVENTION

The above mentioned problems can be solved by creating an automated time management process that works by budgeting time similar to budgeting money, the system can then intelligently maximize how the user uses their time.

The automated time budgeting approach offers many advantages to traditional time and project management systems. The goal of the invention is to integrate time and project management systems by use of an automated budgeting approach that is simple and easy to use, providing maximum flexibility to the user and highest and best production output from the user. The Internet, computers and other portable electronic devices are the ideal input and output devices to track the users schedule.

First the user determines the resources available and has the ability to change the number of hours available. Exceptions to time availability can be accommodated, i.e. days off, and time available per day. The user can then schedule tasks. Tasks are categorized into fixed and variable tasks. Fixed tasks are tasks that have to be done in a certain block of time, for instance a meeting. Another type of fixed tasks includes tasks that have to be done at a certain time for a process that is in place. The third type of fixed task is a task that is done repetitively to develop a skill.

All fixed tasks are subtracted from the time available in the amount of time allocated to a given day. The remaining time is then available for variable tasks. Variable tasks are tasks that have a due date, an estimated time required, are created for a certain client or project, and potentially have dependencies on other tasks that must be finished before or after the given task. Variable tasks should ideally be spread between a few days to a few weeks depending on the size of the task.

The tool analyzes the variable tasks every time the schedule changes by using an algorithm to calculate which tasks should be done today and lays out a plan for future tasks. The algorithm is a powerful component in the automated time budgeting process because it adjusts for all new tasks, completed tasks, and omitted tasks, continuously adapting to all changes and providing maximum flexibility for all users.

Tasks that need to be delegated to others can easily be sent by communication devices and accepted by users using the same tool.

### BRIEF DESCRIPTION OF THE DRAWINGS

FIG. 1 is an overview block diagram of how the entire system functions.

FIG. 2 is a block diagram of how tasks are added and which fields may be required. One or multiple users can add tasks. Tasks created by other users have a small feedback loop for task acceptance.

FIG. 3 is a block diagram of how much time is available. First the weekly loop is established, then the exceptions are set, other adjustments can be made. Fixed tasks are also subtracted from the total time available per day.

FIG. 4 is a block diagram of the algorithm for scheduling variable tasks.

### DETAILED DESCRIPTION OF THE DRAWINGS

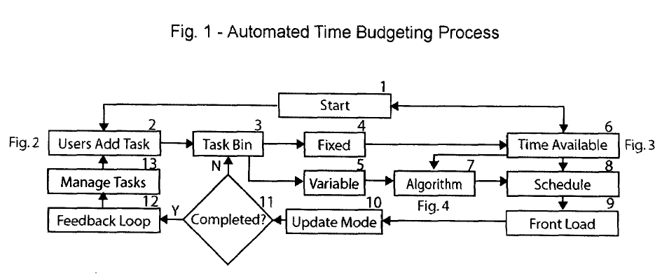

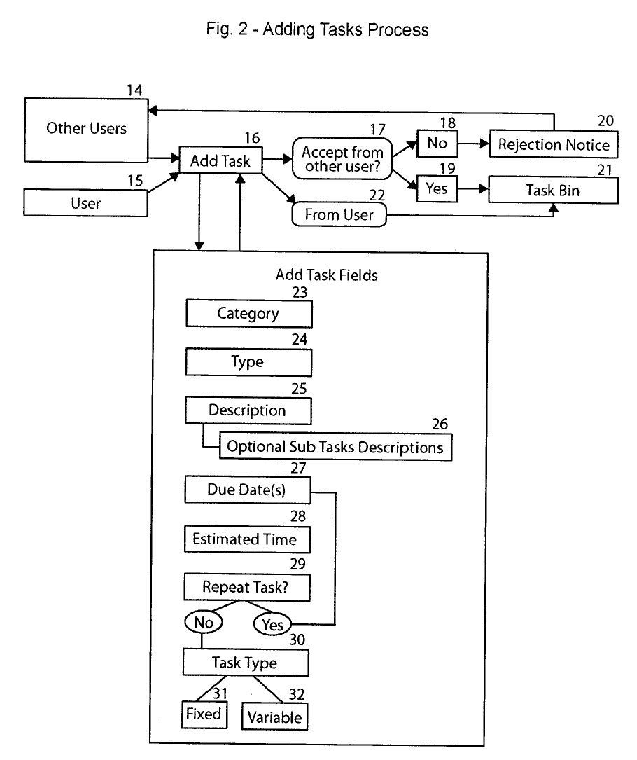

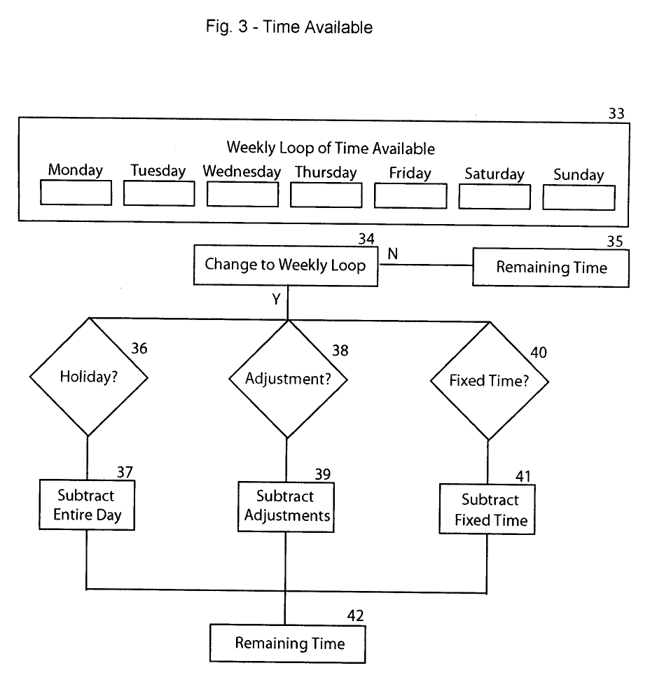

FIG. 1 demonstrates the overall process of automated time budgeting. Start at 1 where the user proceeds by entering Time Available 6, see also FIG. 3, or by adding tasks 2, see also FIG. 2. If the user does not yet have their Time Available entered, they would normally proceed there first. Otherwise, one or more tasks would be entered 6 as the start of the process. FIG. 2 shows the detail of the task entry process. There are two ways to receive tasks for a user. One is by entering them directly, and the other is by receiving them from someone else. When a user 15 wants to enter a task to his schedule, they add a task 16 by entering various fields. The category 23 is a user-defined group label that serves as a means to classify tasks. It may identify a project, client, course of study, or other grouping. The type 24 can be used as a classification of a task's priority relative to the other task types. The description 25 is a required field that labels the task, and is the name by which the user identifies the task. Optionally, sub-tasks 26 can be described if desired. The date 27 is a required field that identifies the due date for completion of a task, or the date on which a fixed task or event should be scheduled. The estimated time 28 is a required field that identifies the estimated time required to complete the task, or the duration of a fixed task or event. A task may optionally be classified as a repeating task 29 meaning that it would have multiple due dates 27, one for each instance of repetition. A task can also be classified with a task type 30 identifying it as a fixed 31 task, meaning it occurs on a specific date in the schedule, or variable 32 task, meaning it should be scheduled flexibly given the fixed tasks and time available.

After adding a task 16, if the task is being directly entered by the user 22, it goes into the task bin 21 directly. If the user is receiving a task 16 from another user they may choose whether they will accept the task 17. If they accept the task 19 it is added to their task bin 21. If they choose not to accept the task 18 a rejection notice 20 is sent to the user who sent the task 14 and the task never enters the user's task bin 21.

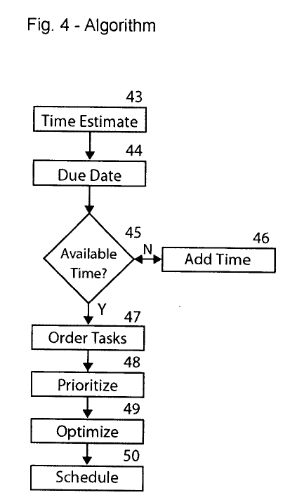

Adding a task as shown in FIG. 2 corresponds to item 2 in FIG. 1, and the task bin shown in 21 on FIG. 2 corresponds to the task bin shown in 3 on FIG. 1. The process of budgeting time can proceed once one or more tasks are in the task bin 3, which could simply be a list of tasks. Fixed tasks 4 may be added to the schedule 8 after updating the time available 6 on any impacted days recorded for later use by the task scheduling algorithm 7. Variable tasks 5 are scheduled by the algorithm 7 illustrated in FIG. 4 and are described hereafter. The algorithm 7 decides how to add the task to the schedule 8. Once the initial schedule 8 is ready, an optional process of “front loading” 9 can adjust the schedule to move scheduled tasks to an earlier date if extra time is available on those days. This is beneficial because it avoids procrastination, ensures that any tasks are worked on as soon as time is available, and preserves as much future time as possible for later tasks that may be added to the schedule.

When the schedule is finished and presented to the user, they have the opportunity to update the schedule 10, wherein they can enter work they have completed 11, thus updating the remaining time estimated for a task. If the task is not yet entirely complete, it returns to the task bin 3 to be rescheduled with its new time estimate. If the task is finished, it can optionally become part of a feedback loop 12 whereby the user can receive feedback, reporting, and other data that can help the user measure and improve their use of time. The user also has the opportunity to manage tasks 13 in their schedule, updating any of the data entered when adding the task 2, or delegating it to another user by sending the task to them, where upon the receiving user would be given the opportunity to accept or reject the delegated task. This may be particularly useful for teams where team members or managers may assign tasks to other team members.

FIG. 3 describes the time available, and corresponds to 6 in FIG. 1. One possible implementation for time available could center around a weekly loop 33 that assigns time available by the day of the week, having an available time setting for each day of the week, and repeating that pattern every week. Exceptions to the standard pattern 34 could be made if desired. One exception may be a holiday 36, which would cause the entire day's available time to be deducted 37. It may simply be an adjustment to the available time 38, meaning that the difference would be added or subtracted 39 from the time available. Another factor are fixed tasks 40, which have their estimated time or duration deducted 41 from the available time. These and any other changes, adjustments or exceptions contribute to the remaining time 42. If no changes are made, the remaining time 35 on each day simply follows the standard weekly pattern 33.

FIG. 4 describes the algorithm for scheduling variable tasks, and corresponds to 7 in FIG. 1. The schedule 50 shown in FIG. 4 corresponds to the schedule 8 in FIG. 1. One input to the algorithm is the available time, as shown in 6 of FIG. 1, also known as remaining time in 42 and 35 on FIG. 3. The other information comes from the task itself, including the time estimate 43 and the due date 44. The task, or if desired, any subdivided task portions, is generally scheduled for dates no later than the due date 44. Any task portions are assigned time estimates such that the sum of the task portion times is equal to the total task time estimate 43. When a day is selected to schedule a task or task portion, the available time 45 is examined. If no time is available that day, time may optionally be added 46 by the algorithm if it determines that over-booking the user's schedule is desirable or necessary for getting all the tasks into the schedule prior to their respective due dates. If sufficient time is available to schedule a task portion, the algorithm may determine in what order the tasks on that day should be scheduled 47, and may take into account their relative priorities 48. The time to be scheduled in this task portion may also be optimized 49 according to task data or to user preferences. Then the task or task portion is added to the schedule 50.

1. A method for scheduling tasks or events whereby a plurality of tasks or events, each receiving an estimate of the time required to perform such task or the time of duration of such event, is organized into a schedule or calendar, suitable as a guide in performing said tasks and events.

2. The method of claim 1 wherein the schedule is organized by means of a computerized program or algorithm whereby said method can be automated.

3. The method of claim 1 wherein tasks can be reorganized in said calendar as tasks are added or deleted, while maintaining specific tasks or events in a fixed position in the schedule as needed.

4. The method of claim 1 wherein a network of computer systems, including but not limited to the internet, is utilized whereby said tasks or events may be submitted, or said schedule may be transmitted.

5. The method of claim 1 wherein a web site is used whereby said tasks or events may be submitted, or said schedule may be transmitted.

6. The method of claim 1 wherein said tasks or events receive a due date whereby the schedule can be made to reflect the completion of each task or event on or prior to its respective due date.

7. The method of claim 1 wherein said tasks or events receive one or more classifications whereby tasks or events having different classifications can be given preferential or other special or unique treatment relative to other tasks or events.

8. The method of claim 1 wherein said tasks or events may be designated as being required to occur on a specific date or at a specific time, whereby to allow said tasks or events to be respectively organized into the corresponding timeframe in said schedule or calendar.

9. The method of claim 1 wherein said tasks or events may be subdivided into a plurality of task portions, such that the sum of the time estimates for the task portions is equal to the time estimate for the entire task, whereby said task portions can be organized into said schedule or calendar in multiple dates or timeframes such that each task portion can be performed independently, and said entire task is considered performed when all its respective task portions have been performed.

10. The method of claim 1 wherein said tasks or events are organized into a schedule or calendar such that said tasks or events do not overlap or occur simultaneously when performed according to said schedule or calendar.
